(19) United States
(12) Patent Application Publication
(10) Pub. No.: US 2014/0347440 A1
(43) Pub. Date: Nov. 27, 2014

(54) Omnidirectional Vehicle Camera System

(71) Applicant: Sylvester Hatcher, Birmingham, AL (US)

(72) Inventor: Sylvester Hatcher, Birmingham, AL (US)

(21) Appl. No.: 14/286,042

(22) Filed: May 23, 2014

Related U.S. Application Data
(60) Provisional application No. 61/826,807, filed on May 23, 2013.

(51) Int. Cl. B60R 11/04; H04N 5/232

(52) U.S. Cl. CPC B60R 11/04; H04N 5/23238
USPC 348/36

(57) ABSTRACT

A video surveillance system adapted for use with vehicles is provided. The present invention comprises a housing having a plurality of cameras disposed around its periphery, a means for multiplexing the captured video footage into a single video feed, a removable storage medium that is preferably directly connected to the housing via a video cable or other such video transmitter. Furthermore, the present invention is either permanently or removably affixed to an individual's automobile. Each of the cameras is non-rotational, but they have a field of view such that the entire 360 degree area surrounding the present invention is simultaneously and continuously recorded. The present invention thereby provides an uninterrupted and complete video record of all of the events that occurred surrounding the user's vehicle.

### CROSS REFERENCE TO RELATED APPLICATION

This application claims the benefit of U.S. Provisional Application No. 61/826,807 filed on May 23, 2013, entitled “Auto Cam.” The above identified patent application is herein incorporated by reference in its entirety to provide continuity of disclosure.

### BACKGROUND OF THE INVENTION

1. Field of the Invention

The present invention relates to video recording devices. More specifically, the present invention relates to video recording devices that are adapted to be attached to the top surface of a car and have a three hundred and sixty degree field of vision.

It is often desirable to have a video record of events that occur to vehicle, such as a car accident or if an individual attempts to break into the vehicle. A video record of a car accident can quickly and easily resolve disputes between drivers and provide visual evidence for police officers or insurance companies. Furthermore, a video record of an attempted or successful break-in can provide visual evidence that can be used to identify the perpetrator and speed up the process of that individual being brought to justice. Alternatively, if individuals recognize the conspicuous presence of the vehicle-attached video recording system, then they may choose to drive more carefully around the user or not break into the user's car because they will know that the user will have access to a video record of their misconduct.

Currently available vehicle-mounted video recording devices suffer from a number of drawbacks. First, many of these systems use rotating cameras to cover the entire field of view surrounding the vehicle. Rotating cameras are undesirable because they can introduce defects to the recorded video footage, including screen tearing. These defects negatively affect the quality of the video footage and potentially make said video footage more challenging to use the video footage for its purpose, such as identifying the identities of individuals that attempt to break into the vehicle or viewing what actions led to a car accident. Second, many of these systems are directly integrated into the vehicle and therefore rely upon the vehicle's power source. Because they rely on the vehicle's power source, these video surveillance systems cannot capture video when the vehicle is not itself on or otherwise in use. This is disadvantageous because many activities, such as break-ins, that a user would wish to record do not strictly occur when the vehicle is in use. Third, many of these systems either begin recording or begin permanently storing the captured video feed upon the occurrence of a pre-determined event or series of events. These devices function this way in order to preserve data storage space because otherwise the system would not be able to store the huge amount of data inherent from continuously capturing video data. However, because these systems rely on sensors to detect the occurrence of the programmed event or events, they can generate false negatives and therefore fail to record the desire video footage. Furthermore, it can be very difficult to anticipate every single possible instance in which an individual would want the system to be recording video. This ultimately leads to occasions where users are negatively impacted by the fact that their vehicle video surveillance system was not recording video data. Because data storage systems have grown increasingly inexpensive and are able to store increasingly large amounts of data, it is now generally more desirable to sacrifice the memory storage to instead have a reliable, continuous video record of all the events that have occurred surrounding the individual's vehicle.

In order to address these and other problems, the present invention provides an omnidirectional video capture system that is adapted for use with vehicles, such as automobiles. The present invention comprises a housing that is affixable to a vehicle and has a plurality of non-rotational video cameras that are arranged to cover the entire field of view surrounding the vehicle to which the housing is attached. Furthermore, the present invention comprises its own separate rechargeable power source so that the present invention does not rely upon the vehicle's integral power system, thereby providing the present invention with the ability to record video footage whether or not the vehicle is in use. The present camera system also continuously records video footage, regardless of the occurrence of an event or a variable, thereby eliminating the potential for false negatives and ensuring that every event that an individual would wish to be recorded is in fact recorded.

2. Description of the Prior Art

Devices have been disclosed in the prior art that relate to automobile-based recording devices. These include devices that have been patented and published in patent application publications. These devices generally relate to video recording devices that are mounted either to the rear view mirror or to the top roof of the car. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 5,978,017 to Tino, which discloses a multi-camera video recording system for vehicles comprising a combination rear view mirror and four-camera assembly and a four-to-one video multiplexer to combine four separate video inputs into a single output. The cameras are positioned such that one is aimed at the front of the vehicle, two are aimed to the sides, and one cameras is aimed at the rear portion of the vehicle. The present invention also utilizes a four-camera system; however the present system is adapted to be mounted to the top roof portion of the automobile, whereas Tino utilizes a self-contained rear view mirror housing.

Another such device is U.S. Pat. No. 6,333,759 to Mazzilli, which discloses an automobile camera system that is adapted to capture video in a 360 degree range around the camera. Mazzilli comprises a housing that is mounted onto the support portion of a rear view mirror, a plurality of cameras positioned on the housing such that they provide a full 360 degree view of the inside and the outside of the automobile, a multiplexer unit, and a VCR recorder for storing the captured video. The present invention, on the other hand, is adapted to be mounted to the exterior of the roof of the automobile and has a means for video playback on a secondary electronic device, such as a laptop.

U.S. Patent Application Publication No. 2006/0139454 to Trapani discloses a vehicle roof-mounted video recording system that indexes the captured surveillance footage with time and location data. The time and location-synchronized video data can then be combined with other video footage sources to create an accurate visual reproduction of a recorded event. The camera system of Trapani comprises a single camera or a plurality of cameras that are adapted to capture video in a 360 degree view around the automobile. The present invention also comprises a camera system that is adapted to capture video in a 360 degree view around the automobile; however, the present invention further comprises a physical storage medium that is stored at a separate location within the car and that is removable therefrom.

Another such device is U.S. Patent Application Publication No. 2007/0219686 to Plante, which discloses a vehicle event recording system that transmits captured data, including video, over a wireless mobile telephone communication network upon the occurrence of an event, such as a car accident. The present invention, on the other hand, utilizes a storage medium to store captured video data that is physically present within the automobile. Furthermore, the present invention captures data continuously, regardless of whether a pre-programmed event has occurred. This is advantageous because making the storage of the captured video data contingent upon variables measured by sensors can result in false negatives, resulting in events the user wished to be recorded not actually being recorded.

Finally, U.S. Patent Application Publication No. 2012/0236112 to Cilia discloses a video surveillance device adapted for use with police vehicles, comprising an omnidirectional video camera, a digital processor adapted to locate pre-defined regions of interest within the captured video or image data, and a means for compressing and storing said data. Unlike in Cilia, the video storage means of the present invention is a self-contained removable unit that it is located at a separate location within the automobile from the video-capturing components of the present invention.

These prior art devices have several known drawbacks. In many of these systems the recordation or the storage of the video data is dependent upon the occurrence of a pre-determined event or a series of pre-determined events, as measured by various sensors. These systems attempt to save storage space by creating an event-responsive system. This is an undesirable characteristic because relying upon sensors can create false negatives wherein the system fails to detect the occurrence of the event the user wishes to record and therefore fails to record said event. This can be extremely disadvantageous when the user is relying on these systems to settle insurance disputes or to determine the identity of an individual who has broken into the car. Storage mediums have become increasingly inexpensive and are capable of storing increasingly large amounts of data, thereby making it more attractive to capture as much video data as possible and not worry about saving storage space. Furthermore, users may not always know exactly what types of events that they will wish to have a record of; if an unanticipated event occurs, then the system will not recognize the occurrence of that event and the recording will be lost. Lastly, many omnidirectional recording systems rely upon a single or a series of rotating cameras to cover the entire 360 degree view around the automobile or vehicle. This is also disadvantageous because rotating video cameras can creating screen tearing and other video artifacts that negatively impact the quality of the recorded image. Therefore, there is a need in the prior art for an omnidirectional video recording system that is adapted for use with automobiles and other vehicles that utilizes static cameras and continuously records video, regardless of the occurrence of a pre-programmed event.

The present invention comprises a housing containing four separate video cameras, wherein each camera has at least a 90 degree field of vision and wherein the cameras are positioned such that in combination they cover the entire 360 degree view about the vertical axis of the vehicle. The present invention further comprises a multiplexing video cable that combines each of the separate cameras' video data into a single data stream that is stored within a physical storage medium that is located in the vehicle, such as in the trunk of an automobile. The cameras are static and continuously capture video data within their field of vision. The storage medium is removable from the vehicle and further comprises a video playback means so upload and then replay captured video images on a connected secondary electronic device, such as a laptop.

The present invention substantially diverges in design elements from the prior art and consequently it is clear that there is a need in the art for an improvement to existing omnidirectional vehicle video surveillance devices. In this regard the instant invention substantially fulfills these needs.

### SUMMARY OF THE INVENTION

In view of the foregoing disadvantages inherent in the known types of vehicle video surveillance devices now present in the prior art, the present invention provides a new omnidirectional vehicle video system wherein the same can be utilized for providing convenience for the user when seeking to record the occurrence of all events that happen in the vicinity of his or her automobile.

It is therefore an object of the present invention to provide a new and improved omnidirectional vehicle camera system that has all of the advantages of the prior art and none of the disadvantages.

It is another object of the present invention to provide an omnidirectional vehicle camera system that has a 360 degree field of vision about the vertical axis of the vehicle to which it is affixed.

Another object of the present invention is to provide an omnidirectional vehicle camera system that is removably affixable to a vehicle.

Yet another object of the present invention is to provide an omnidirectional vehicle camera system that utilizes static cameras.

Yet another object of the present invention is to provide an omnidirectional vehicle camera system that has a removable storage medium.

Still yet another object of the present invention is to provide an omnidirectional vehicle camera system that comprises a video playback means.

Still yet another object of the present invention is to provide an omnidirectional vehicle camera system that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a perspective view of the camera housing portion of the present invention.

FIG. 1B shows an overhead view of the camera housing portion of the present invention with depictions of the cameras' fields of view.

FIG. 2 shows an overhead view of the present invention affixed to an automobile.

FIG. 3 shows a diagram of the video capturing, storage, and playback systems of the present invention.

### DETAILED DESCRIPTION OF THE INVENTION

Reference is made herein to the attached drawings. Like reference numerals are used throughout the drawings to depict like or similar elements of the omnidirectional vehicle camera system. For the purposes of presenting a brief and clear description of the present invention, the preferred embodiment will be discussed as used for capturing video image data around an automobile. The figures are intended for representative purposes only and should not be considered to be limiting in any respect.

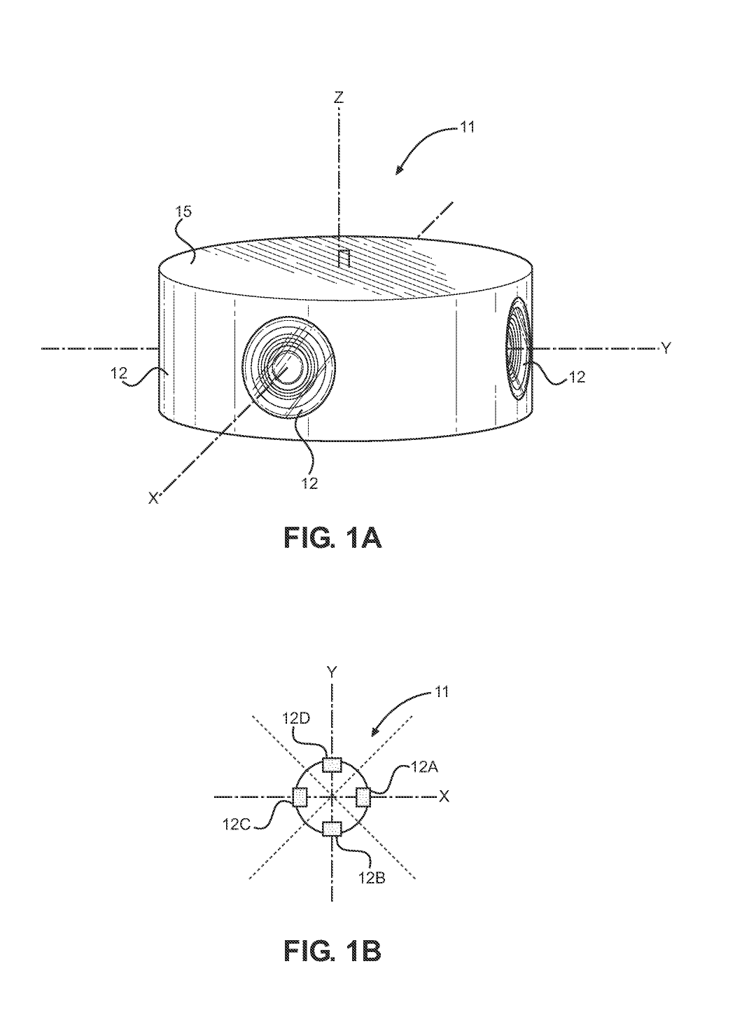

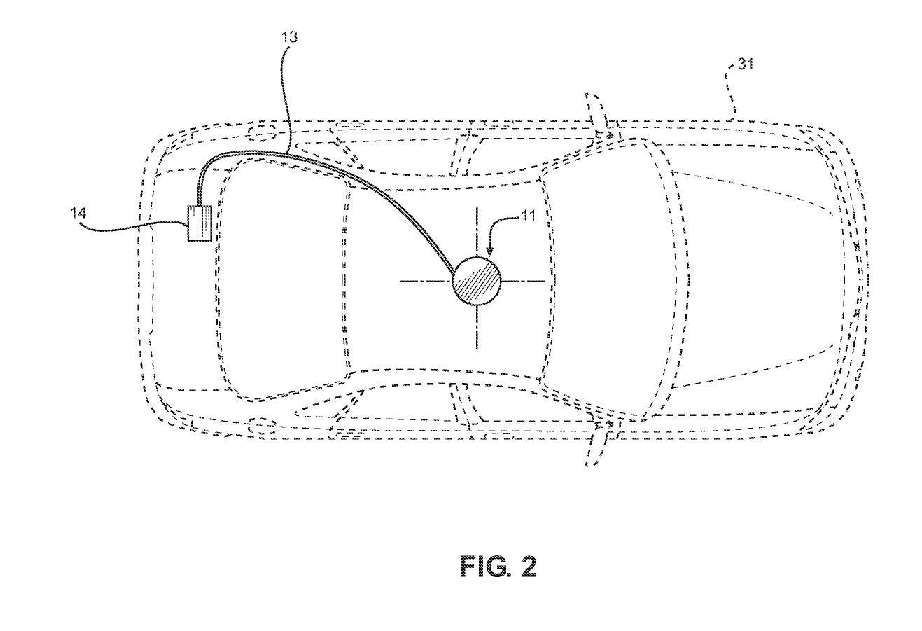

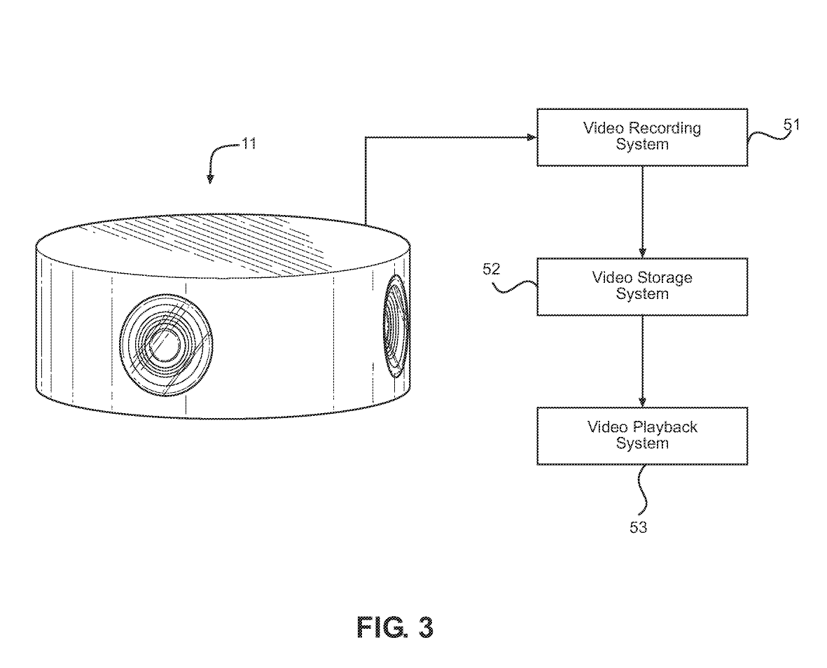

Referring now to FIGS. 1A and 2B, there are shown perspective and overhead views of the camera housing portion of the present invention. The present invention comprises a housing 11 with a plurality of non-rotational, aligned cameras 12 disposed around the perimeter of the housing 11 such that said cameras 12 are arranged to capture video in a 360 degree radius around the vertical axis of the housing 11. In the depicted embodiment of the present invention, the housing 11 is a cylindrical unit with a top surface, bottom surface, and a side surface defining the circumference of the unit. Furthermore, the depicted embodiment has four cameras 12A-D disposed at 90 degree angles relative to each other along the circumference of the cylindrical housing 11. Each camera 12A-D is adapted to have a 90 degree field of view so that the cameras 12A-D, in combination, cover the entirety of the 360 degree radius about the vertical axis of the housing 11 without the need to move or rotate. This configuration ensures that the entire area around the vehicle is captured on video at all times without any interruption.

The housing 11 is either removably or permanently affixable to the roof portion of a vehicle, depending upon the embodiment of the present invention. In embodiments wherein the housing 11 is permanently affixed to the roof of the automobile, the housing 11 is attached thereto via welding, fasteners, or any other such form of permanent connection. In embodiments of the present invention wherein the housing 11 is removably affixed to the roof portion of the vehicle, the bottom surface of the housing 11 has any type of removable connector disposed thereon, such as suction cups, magnets, and the like. Although the present invention is described as affixed to the roof portion of a vehicle, it would be recognized by a person having ordinary skill in the art that the present invention is affixable to a variety of different surfaces and portions of a vehicle to provide a 360 degree view from said location.

The cameras 12 function as conventional video capturing devices as are commonly known in the prior. The housing 11 further contains the necessary circuitry to capture, record, process, store, and transmit video images via the plurality of cameras 12. It is submitted that such video capture, recording, and transmitting means are well known in the prior art. The cameras 12 together cover a 360 degree field of view without rotating or otherwise moving in any way, thereby eliminating screen tearing and other such video artifacts associated with other systems that utilize moving cameras to cover the entire field of view surrounding the housing 11. In one embodiment of the present invention, each camera 12 has a field of view equal to 360/n degrees, where n is equal to the number of cameras. Therefore, the edges of the fields of view of the cameras perfectly abut each other in order to reduce the need for additional post-capture video processing to combine the captured images.

Referring now to FIG. 2, there is shown an overhead view of the present invention affixed to an automobile. The present invention comprises a housing 11 that supports a static, omnidirectional camera system, a storage medium 14 located at a separate position within the vehicle 31, and a video cable 13 to transmit captured video data from the camera system to the storage medium 14. The housing 11 contains a multiplexer, which combines the video feeds captured from each of the cameras into a signal video stream. The combined video feed is then transmitted to the storage medium 14 via the video cable 13. The multiplexed video feed is then stored as a single unit, thereby allowing users to access the 360 degree captured video data from the plurality of cameras as a single video file. The video cable 13 is preferably removably affixed to both the housing 11 and the storage system 14, thereby allowing both of said components to be removed from the vehicle 31. The camera system continuously captures video footage as long as the storage medium 14 is connected thereto via the video cable 12 or other connector. If the storage medium 14 is disconnected from the housing 11, then the camera system automatically halts video capture in order to preserve energy.

The storage system 14 comprises any computer storage device that is adapted to record and retain digital data transmitted thereto. The storage system 14 is removably secured to the vehicle 31 so that it can be removed therefrom and the video can be uploaded from it and viewed on a secondary electronic device, such as a laptop. The storage system 14 preferably further comprises the battery or other such device that powers the present invention. The present invention utilizes a separate power source from that of the car itself so that the present invention is able to monitor the user's vehicle 31 even when the vehicle 31 is not in operation, deterring break-ins and other such undesired activity. The power source contained with the storage system 14 comprises a means for accepting a rechargeable battery, an internal battery that is rechargeable via a conventional electrical plug, a USB connection, and the like, and other such rechargeable power sources. The video cable 13 provides a two-way connection between the storage system 14 and the housing 11, wherein the camera system transmits video data to the storage system 14 and the storage system 14 transmits power to run the camera system back to the housing 11.

The present invention incorporates three separate systems: the video recording system 11, the video storage system 52, and the video playback system 53. The video recording system 51 comprises the plurality of cameras disposed about the housing 11 and the necessary circuitry to capture, record, multiplex, and then transmit the multiplexed video data. The video storage system 52 comprises a digital data storage medium that is adapted to receive the multiplexed video data generated by the video recording system 51 and store it indefinitely for later access. The video playback system 53 comprises a means to upload indexed video data from the video storage system 52 for playback on a secondary electronic device, such as a laptop.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A non-rotational, omnidirectional video camera system, comprising:
a housing having a plurality of cameras, wherein said cameras are arranged to record a 360 degree field of view surrounding said housing;
a multiplexer adapted to combine video captured via said cameras into a single video stream;
a video transmitter for transmitting said multiplexed video stream to a storage medium;
wherein said housing is removably affixable to a vehicle;
wherein said storage medium is adapted to store said multiplexed video stream and upload said multiplexed video stream to an electronic device for video playback.

2. The non-rotational, omnidirectional video camera system of claim 1, wherein said cameras number four and are disposed at 90 degree angles relative to each other.

3. The non-rotational, omnidirectional video camera system of claim 2, wherein said housing is cylindrical.

4. The non-rotational, omnidirectional video camera system of claim 1, further comprising a power source.

5. The non-rotational, omnidirectional video camera system of claim 4, wherein said power source and said storage medium are contained within a single housing.

6. The non-rotational, omnidirectional video camera system of claim 4, wherein said power source is rechargeable.

7. The non-rotational, omnidirectional video camera system of claim 5, wherein said power source is rechargeable.

8. The non-rotational, omnidirectional video camera system of claim 1, wherein said storage medium is removably affixed to a vehicle.

9. The non-rotational, omnidirectional video camera system of claim 5, wherein said power source and said storage medium housing is removably affixed to a vehicle.
